(19) United States
(12) Patent Application Publication
(10) Pub. No.: US 2018/0282539 A1
(43) Pub. Date: Oct. 4, 2018

(54) THERMOPLASTIC POLYESTER RESIN COMPOSITION AND LIGHT REFLECTOR USING SAME

(71) Applicant: TOYOBO CO., LTD., Osaka (JP)

(72) Inventors: Junichi YASUI, Otsu-shi, Shiga (JP); Satoru HORIGUCHI, Otsu-shi, Shiga (JP); Takuya SHIMOHARAI, Otsu-shi, Shiga (JP)

(73) Assignee: TOYOBO CO., LTD., Osaka (JP)

(21) Appl. No.: 15/756,761

(22) PCT Filed: Aug. 24, 2016
(86) PCT No.: PCT/JP2016/074662

§ 371 Date: Mar. 1, 2018

(30) Foreign Application Priority Data
Sep. 2, 2015 (JP) 2015-172882

(51) Int. Cl. C08L 67/02; C08J 3/20; B29D 11/00; G02B 1/04; G02B 5/08

(52) U.S. Cl. CPC C08L 67/02; C08J 3/201; B29D 11/0074; G02B 1/04; G02B 5/0866; B29K 2067/006; C08L 2205/03; C08J 2367/02; C08J 2467/02; C08J 2425/06; C08L 2205/025

(57) ABSTRACT

The present invention is directed to a thermoplastic polyester resin composition that contains 100 to 50 parts by mass of a polybutylene terephthalate resin (A) and 0 to 50 parts by mass of a polyethylene terephthalate resin (B), and contains 1 to 20 parts by mass of a surface-treated calcium carbonate (C) having an average particle size of 0.05 to 2 μm and 0.05 to 3 parts by mass of a multifunctional glycidyl group-containing styrene-based polymer (D) with respect to 100 parts by mass of the total polyester resin contained in the resin composition.

### TECHNICAL FIELD

The present invention relates to a thermoplastic polyester resin composition used for a light reflector component on a surface of which a light-reflecting layer is to be formed, among components constituting an automotive lamp, a lighting fixture, etc., for example, a light reflector component made of the same, and a light reflector having the light reflector component on part or the entire of which a light-reflecting metal layer is directly formed.

### BACKGROUND ART

Extensions, reflectors, etc. used for automotive lamps, etc. and light reflectors for lighting fixtures, etc. are required to have appearance with high brightness, uniform reflectivity, heat resistance against heat generation by light from a light source, etc. as their performance. For such products, conventionally, ones such as a bulk molding compound (hereinafter abbreviated as BMC), which is a thermosetting resin, having a metal thin film provided on a surface have been used.

The BMC is excellent in heat resistance, dimension stability, etc., but is long in molding cycle, and has a problem that it takes a lot of trouble to deal with occurrence of burrs during molding, reducing the productivity, and a problem that gas is generated due to monomer volatilization, worsening the work environment. As a means for solving these problems, use of a thermoplastic resin has been examined.

As an example of use of a thermoplastic resin, proposed has been composition where various reinforcing materials are blended to a crystalline resin represented by a polyester resin such as polybutylene terephthalate and polyethylene terephthalate, an amorphous resin represented by a polycarbonate resin, etc. Among others, for light reflectors where mechanical properties, electrical properties, heat resistance, good moldability, etc. are required, especially, composition of a polybutylene terephthalate resin alone or a mixture of polybutylene terephthalate and another resin blended with various reinforcing materials has been widely adopted.

As a technique of forming a metal thin film, etc. for a molded article made of the above thermoplastic resin composition for imparting performance as a light reflector, there is a method of performing pretreatment of undercoating before formation of a light-reflecting metal layer on the molded article. In this conventional method of performing undercoating, the load to the environment is large because an organic solvent is used in the undercoat. Moreover, the cost required for the undercoating process is high because it takes time to volatilize the organic solvent and harden the coat. This method therefore has a problem of increasing the total cost. In view of the above, there has been a need for a thermoplastic resin composition for a light reflector for which a direct method of forming a metal layer directly without the necessity of any pretreatment process is possible.

In performing direct metallization by the direct method, a resin molded article itself needs to have good surface smoothness and high glossiness and brightness feeling. For this reason, it is necessary to use a material in which generation of gas during molding is restrained. With increase in the number of times of molding, when continuous molding is performed, residues on mold originating from decomposed matters of a resin, decomposed matters of a mold release agent, etc. generated during molding occurs. The shape of deposited residues on mold may be transferred to the molded article, impairing the appearance of the molded article. In particular, in components constituting automotive lamps and lighting fixtures, a light reflector component on a surface of which a light-reflecting layer is to be formed, etc., appearance with high brightness, uniform reflectivity, etc. are required. For this reason, in these uses, it is necessary to clean the mold frequently. Thus, there has been a need for a molding material in which residues on mold are restrained.

As resin compositions that can be metallized by the direct method, there are those proposed in Patent Documents 1 and 2 (hereafter referred to as “PTD 1” and “PTD 2”), for example. In PTD 1 and PTD 2, while selection of a mold release agent has been made to improve heat resistance after metallization, gas is largely generated from the resin content during molding, and thus it is unable to restrain residues on mold. In PTD3, while gas generation during continuous molding has been examined including the heat resistance of a mold release agent, examination has only been made on selection of the mold release agent.

Further, in order to improve the dimension stability of a product, blending of various inorganic fillers has been proposed. For example, PTD4 proposes blending of approximately 10% by mass of a fine-powder spherical inorganic filler such as fired kaolin, barium sulfate, and titanium oxide. However, aggregation of filler particles may occur, impairing the appearance. Also, since the specific gravities of fillers made of barium sulfate and titanium oxide are large, the weight of the molded article may become too large.

### CITATION LIST

### Patent Document

### PTD1: Japanese Patent Laying-Open No. 2008-280498

### PTD2: Japanese Patent Laying-Open No. 2009-102581

### PTD3: Japanese Patent Laying-Open No. 2010-189584

### PTD4: Japanese Patent Laying-Open No. 2009-235156

### SUMMARY OF INVENTION

### Technical Problems

An object of the present invention is to provide a thermoplastic polyester resin composition not only capable of providing a molded article suitable for formation of a light-reflecting surface of a light reflector and having excellent surface smoothness, low fogging properties, and light weight, but also capable of restraining residues on mold at the time of continuous molding.

### Solutions to Problems

As a result of keen examinations, the present inventors have found that it is possible to attain the object by using a specific polyester resin as a matrix and blending specific calcium carbonate, a specific multifunctional glycidyl group-containing styrene-based polymer, etc., and have completed the present invention.

That is, the present invention is as follows:

[1]

A thermoplastic polyester resin composition containing 100 to 50 parts by mass of a polybutylene terephthalate resin (A) and 0 to 50 parts by mass of a polyethylene terephthalate resin (B), the resin composition containing 1 to 20 parts by mass of a surface-treated calcium carbonate (C) having an average particle size of 0.05 to 2 μm and 0.05 to 3 parts by mass of a multifunctional glycidyl group-containing styrene-based polymer (D) with respect to 100 parts by mass of a total polyester resin contained in the resin composition.

[2]

The thermoplastic polyester resin composition according to [1], wherein the surface treatment of the ingredient (C) is one kind or two or more kinds selected from silica treatment, epoxysilane coupling agent treatment, and alkylsilane coupling agent treatment.

[3]

The thermoplastic polyester resin composition according to [1], wherein the surface treatment of the ingredient (C) is any of silica treatment, composite treatment of silica treatment and epoxysilane coupling agent treatment, and composite treatment of silica treatment and alkylsilane coupling agent treatment.

[4]

The thermoplastic polyester resin composition according to any one of [1] to [3], which contains 0.01 to 5 parts by mass of a phosphorus compound (E) with respect to 100 parts by mass of the total polyester resin.

[5]

The thermoplastic polyester resin composition according to any one of [1] to [4], wherein the polybutylene terephthalate resin (A) is a polybutylene terephthalate resin having a titanium atom content of less than or equal to 60 ppm.

[6]

The thermoplastic polyester resin composition according to any one of [1] to [5], wherein the polyethylene terephthalate resin (B) is a polyethylene terephthalate resin having an acid value of less than or equal to 30 eq/ton.

[7]

A light reflector component including the thermoplastic polyester resin composition according to any one of [1] to [6].

[8]

A light reflector having the light reflector component according to [7] on at least part of a surface of which a light-reflecting metal layer is directly formed.

[9]

A method for manufacturing a light reflector component, the method including a step of molding by injecting the thermoplastic polyester resin composition according to any one of [1] to [6] into a mold at least part of an inner surface of which is a mirror surface.

[10]

A method for producing a thermoplastic polyester resin composition, the method including a step of melting and kneading at least a polybutylene terephthalate resin (A), a polyethylene terephthalate resin (B), a surface-treated calcium carbonate (C) having an average particle size of 0.05 to 2 μm, and a multifunctional glycidyl group-containing styrene-based polymer (D), wherein a blending ratio of (B) is 0 to 50 parts by mass relative to 100 to 50 parts by mass of (A), and blending ratios of (C) and (D) are 1 to 20 parts by mass for (C) and 0.05 to 3 parts by mass for (D), with respect to 100 parts by mass of a total polyester resin contained in the resin composition.

[11]

The method for producing a thermoplastic polyester resin composition according to [10], wherein, as the polybutylene terephthalate resin (A), a polybutylene terephthalate resin having a titanium atom content of less than or equal to 60 ppm is used.

[12]

The method for producing a thermoplastic polyester resin composition according to [10] or [11], wherein, as the polyethylene terephthalate resin (B), a polyethylene terephthalate resin having an acid value of less than or equal to 30 eq/ton is used.

### Advantageous Effects of Invention

The thermoplastic polyester resin composition of the present invention has advantages not only that a molded article manufactured using the same has light weight and excellent surface specularity, but also that residues on mold at the time of continuous molding can be highly restrained. The resultant molded article is also excellent in low fogging properties.

### DESCRIPTION OF EMBODIMENTS

The present invention will be described hereinafter in detail.

The polybutylene terephthalate resin (A) according to the present invention is a polymer obtained by a general polymerization method such as polycondensation reaction using terephthalic acid or its ester-forming derivative and 1,4-butanediol or its ester-forming derivative as main ingredients. The polymer preferably has a butylene terephthalate repeating unit of greater than or equal to 80 mol %, more preferably greater than or equal to 90 mol %, further preferably greater than or equal to 95 mol %, most preferably 100 mol %. Another copolymerization ingredient may be contained within the range of not impairing the properties, e.g., in an amount of less than or equal to approximately 20% by mass. Examples of a copolymer usable as the polybutylene terephthalate resin (A) include polybutylene (terephthalate/isophthalate), polybutylene (terephthalate/adipate), polybutylene (terephthalate/sebacate), polybutylene (terephthalate/decanedicarboxylate), polybutylene (terephthalate/naphthalate), and poly(butylene/ethylene) terephthalate. The polybutylene terephthalate resin (A) may be made of a single resin or a mixture of two or more kinds of resins.

The polybutylene terephthalate resin (A) according to the present invention is preferably obtained using a titanium catalyst at the time of esterification reaction (or transesterification reaction) between 1,4-butanediol and terephthalic acid (or dialkyl terephthalate). The polybutylene terephthalate resin (A) preferably has a titanium atom content of less than or equal to 60 mg/kg (60 ppm). The mass of the polybutylene terephthalate resin (A) includes the mass of the titanium catalyst.

As the titanium catalyst, normally, a titanium compound is used. Specific examples thereof include an inorganic titanium compound such as titanium oxide and titanium tetrachloride; a titanium alcoholate such as tetramethyltitanate, tetraisopropyltitanate, and tetrabutyltitanate; and a titanium phenolate such as tetraphenyltitanate. Among others, tetraalkyltitanates are preferable, and among them, tetrabutyltitanate is especially preferable.

In the polybutylene terephthalate resin (A) according to the present invention, the lower limit of the titanium content is preferably 5 mg/kg, more preferably 8 mg/kg, further preferably 15 mg/kg. The upper limit of the titanium content is preferably 45 mg/kg, more preferably 40 mg/kg, especially preferably 35 mg/kg. If the titanium content is greater than 60 mg/kg, it tends to become hard to exhibit the effect of restraining residues on mold at the time of continuous molding.

Titanium and tin may be used together as a catalyst. Also, in addition to titanium and tin, or in place of titanium and tin, the followings may be used: a reaction catalyst including a magnesium compound such as magnesium acetate, magnesium hydroxide, magnesium carbonate, magnesium oxide, magnesium alkoxide, and magnesium hydrogenphosphate, a calcium compound such as calcium hydroxide, calcium carbonate, calcium oxide, calcium alkoxide, and calcium hydrogenphosphate, an antimony compound such as antimony trioxide, a germanium compound such as germanium dioxide and germanium tetroxide, a manganese compound, a zinc compound, a zirconium compound, and a cobalt compound; and further a reaction aid including a phosphorus compound such as orthophosphoric acid, phosphorous acid, hypophosphorous acid, polyphosphoric acid, and esters and metal salts thereof and sodium hydroxide.

The content of titanium atoms, etc. can be measured, after recovery of metals in the polymer by a method such as wet ashing, using a method such as atomic emission, atomic absorption, and inductively coupled plasma (ICP). According to the present invention, measurement using high-resolution ICP-MS is adopted, which will be described in EXAMPLES later.

The inherent viscosity of the polybutylene terephthalate resin (A) according to the present invention is preferably 0.5 to 1.6 dl/g, more preferably 0.6 to 1.2 dl/g, further preferably 0.7 to 1.0 dl/g. If the inherent viscosity is less than 0.5 dl/g, extrusion moldability will be worsened, causing drawdown of the resin and molding unevenness. If it exceeds 1.6 dl/g, the melt viscosity will increase, worsening flowability at the time of molding. Note that the above inherent viscosity is a value measured at 30° C. using a mixed solvent of phenol/tetrachloroethane (mass ratio: 1/1).

The terminal carboxyl group of the polybutylene terephthalate resin plays a catalytic role for hydrolysis reaction of the polymer, and with increase in the amount of the terminal carboxyl group, hydrolysis is accelerated. Therefore, a lower terminal carboxyl group concentration is preferable. The terminal carboxyl group concentration of the polybutylene terephthalate resin (A) according to the present invention is preferably less than or equal to 40 eq/ton, more preferably less than or equal to 30 eq/ton, further preferably less than or equal to 25 eq/ton, especially preferably less than or equal to 20 eq/ton.

The terminal hydroxyl group of the polybutylene terephthalate resin causes backbiting, acting as a start point for producing tetrahydrofuran and a cyclic oligomer. Therefore, in order to restrain backbiting, a lower terminal hydroxyl group concentration is preferable. The terminal hydroxyl group concentration of the polybutylene terephthalate resin (A) according to the present invention is preferably less than or equal to 110 eq/ton, more preferably less than or equal to 90 eq/ton, further preferably less than or equal to 70 eq/ton, especially preferably less than or equal to 50 eq/ton.

The method of adjusting the terminal carboxyl group concentration and the terminal hydroxyl group concentration of the polybutylene terephthalate resin (A) is not particularly limited, but the following methods can be listed, for example: a method of adjusting the feed ratio of the acid ingredient/glycol ingredient at the time of polymerization of the polybutylene terephthalate resin; a method of adding a terminal blocking agent during polymerization of the polybutylene terephthalate resin; a method of performing heat treatment under vacuum or under nitrogen atmosphere after polymerization of the polybutylene terephthalate resin; and a method of further performing solid-phase polymerization operation for the polybutylene terephthalate resin. Any of the above-listed methods and another method may be combined.

In the method of adding a terminal blocking agent during polymerization, use of a terminal blocking agent reacting with the carboxyl group can reduce the carboxyl group terminal concentration, and use of a terminal blocking agent reacting with the hydroxyl group can reduce the hydroxyl group concentration. In the method of performing heat treatment after polymerization, by intentionally causing backbiting of the terminal butanediol ingredient, the terminal hydroxyl group concentration tends to be low while the terminal carboxyl group concentration tends to be high. The heat treatment after polymerization may be performed immediately before removal when the polymer is still in the molten state, or after removal when it is in the pellet state. Considering the production efficiency, heat treatment after polymerization immediately before removal in the molten state is preferable because the backbiting reaction speed is high. In this method, the terminal carboxyl group concentration and the terminal hydroxyl group concentration are adjustable with the heat treatment temperature and time, etc. In the case of the solid-state polymerization, esterification or transesterification reaction proceeds, so that both the terminal carboxyl group concentration and the terminal hydroxyl group concentration tend to be low. However, since the molecular weight increases with this, it is necessary to adjust the solid-state polymerization temperature and time.

The thermoplastic polyester resin composition of the present invention preferably further contains an organic acid salt of alkali metal or/and alkaline earth metal in an amount of 1 to 500 mg/kg, more preferably 2 to 300 mg/kg, further preferably 3 to 200 mg/kg, as alkali metal or/and alkaline earth metal atoms. If the content of such metal atoms exceeds 500 mg/kg, residues on mold may increase due to decomposition of the resin. If it is less than 1 mg/kg, it may be hard to exhibit the effect of preventing residues on mold at the time of continuous molding.

Specific examples of the organic acid salt of alkali metal or/and alkaline earth metal usable for the thermoplastic polyester resin composition of the present invention include lithium acetate, sodium acetate, potassium acetate, calcium acetate, magnesium acetate, lithium gluconate, sodium gluconate, potassium gluconate, calcium gluconate, lithium benzoate, sodium benzoate, and potassium benzoate. Among others, a potassium compound is preferably used, and potassium acetate is especially preferable. Note that only one kind of these organic carboxylic acid salts may be used or two or more kinds thereof may be used together.

The method of introducing any of the above organic acid metal salts into the composition is not particularly limited, but the following methods can be adopted: a method of adding the organic acid metal salt at the stage after the esterification reaction (or transesterification reaction), during the polymerization process, or at the stage of termination of the polymerization, during the production of the polybutylene terephthalate resin; a method of attaching the organic acid metal salt to pellet surfaces or osmosing it into pellets after pelletization; and a method of previously producing master pellets containing the organic acid metal salt in high concentration and dry-blending the master pellets.

The polyethylene terephthalate resin (B) according to the present invention is a polymer obtained by a general polymerization method such as polycondensation reaction using terephthalic acid or its ester-forming derivative and ethylene glycol or its ester-forming derivative as main ingredients. The polymer preferably has an ethylene terephthalate repeating unit of greater than or equal to 80 mol %, more preferably greater than or equal to 90 mol %, further preferably greater than or equal to 95 mol %, most preferably 100 mol %. Another copolymerization ingredient may be contained within the range of not impairing the properties, e.g., in an amount of less than or equal to approximately 20% by mass. Examples of a copolymer usable as the polyethylene terephthalate resin (B) include polyethylene (terephthalate/isophthalate), polyethylene (terephthalate/adipate), polyethylene (terephthalate/sebacate), polyethylene (terephthalate/decanedicarboxylate), polyethylene (terephthalate/naphthalate), poly(ethylene/cyclohexanedimethyl)/terephthalate, and poly(butylene/ethylene) terephthalate. These may be used singularly or in a mixture of two or more kinds. By use of the polyethylene terephthalate resin (B), both moldability and direct metallization properties can be highly attained.

The inherent viscosity of the polyethylene terephthalate resin (B) according to the present invention as measured at 30° C. using a mixed solvent of phenol/tetrachloroethane (mass ratio: 1:1) is preferably 0.3 to 1.6 dl/g, more preferably in a range of 0.45 to 1.35 dl/g, further preferably in a range of 0.5 to 1.2 dl/g, most preferably in a range of 0.55 to 1.05 dl/g. With the polyethylene terephthalate resin (B) having an inherent viscosity of 0.3 to 1.6 dl/g, the thermoplastic polyester resin composition of the present invention will have good mechanical properties and moldability.

The terminal carboxyl group of the polyethylene terephthalate resin plays a catalytic role for hydrolysis reaction of the polymer, and with increase in the amount of the terminal carboxyl group, hydrolysis is accelerated. Therefore, a lower terminal carboxyl group concentration is preferable. The terminal carboxyl group concentration of the polyethylene terephthalate resin (B) according to the present invention is preferably less than or equal to 30 eq/ton, more preferably less than or equal to 25 eq/ton, further preferably less than or equal to 20 eq/ton, especially preferably less than or equal to 10 eq/ton.

The method of adjusting the terminal carboxyl group concentration of the polyethylene terephthalate resin (B) is not particularly limited, but the following methods can be listed, for example: a method of adjusting the feed ratio of the acid ingredient/glycol ingredient at the time of polymerization of the polyethylene terephthalate resin; a method of adding a terminal blocking agent during polymerization of the polyethylene terephthalate resin; and a method of further performing solid-phase polymerization operation for the polyethylene terephthalate resin. Any of the above-listed methods and another method may be combined. In the method of adding a terminal blocking agent during polymerization, use of a terminal blocking agent reacting with the carboxyl group can reduce the carboxyl group terminal concentration. In the case of the solid-state polymerization, esterification or transesterification reaction proceeds, reducing the terminal carboxyl group concentration. However, since the molecular weight increases with this, it is necessary to adjust the solid-state polymerization temperature and time.

The blending amounts of the polybutylene terephthalate resin (A) and the polyethylene terephthalate resin (B) in the present invention are 0 to 50 parts by mass of the ingredient (B) with respect to 100 to 50 parts by mass of the ingredient (A), preferably 0 to 40 parts by mass of the ingredient (B) with respect to 100 to 60 parts by mass of the ingredient (A), more preferably 10 to 30 parts by mass of the ingredient (B) with respect to 90 to 70 parts by mass of the ingredient (A), further preferably 15 to 25 parts by mass of the ingredient (B) with respect to 85 to 75 parts by mass of the ingredient (A). While it is possible to improve the surface appearance of the molded article obtained from the resin composition of the present invention by blending the ingredient (B), if the blending amount exceeds 50 parts by mass, the mold releasability during the injection molding of the resin composition will be poor, degrading the molding high-cycle properties, and the heat resistance of the resin tends to decrease.

A thermoplastic polyester resin (F) other than the polyesters (A) and (B) may be blended in the thermoplastic polyester resin composition of the present invention. The polyester resin (F) is a polyester resin having a chemical structure obtainable by polycondensation of aromatic or alicyclic dicarboxylic acid or its ester-forming derivative and diol. Examples of the dicarboxylic acid ingredient constituting the polyester resin (F) include terephthalic acid, isophthalic acid, naphthalenedicarboxylic acid, and cyclohexanedicarboxylic acid. Examples of the diol ingredient constituting the polyester resin (F) include alkylene diol such as ethylene glycol, diethylene glycol, propanediol, butanediol, neopentyl glycol, and an ethylene oxide diadduct of bisphenol A.

Specific examples of the polyester resin (F) include polypropylene terephthalate, polyethylene naphthalate, polybutylene naphthalate, and polypropylene naphthalate.

The total amount of the polybutylene terephthalate resin (A) and the polyethylene terephthalate resin (B) with respect to the total polyester resin contained in the thermoplastic polyester resin composition of the present invention is preferably greater than or equal to 80% by mass, more preferably greater than or equal to 90% by mass, further preferably greater than or equal to 95% by mass, or it may be 100% by mass, from the viewpoint of good surface smoothness of the molded article.

The calcium carbonate (C) according to the present invention is most suitable, among various inorganic fillers, for a light reflector component and a light reflector having the light reflector component on part or the entire of which a light-reflecting metal layer is directly formed, from the standpoint of specific gravity, particle size, dispersibility in the resin composition, handling properties, easy availability, etc.

The calcium carbonate (C) according to the present invention is a light or heavy calcium carbonate. The light calcium carbonate is synthetic calcium carbonate, and the heavy calcium carbonate is natural calcium carbonate. The average particle size of the calcium carbonate (C) according to the present invention as measured by an electron microscope method is 0.05 to 2 μm, more preferably 0.1 to 1 μm, further preferably 0.1 to 0.3 μm, especially preferably 0.1 to less than or equal to 0.2 μm. If the average particle size exceeds 2 μm, the surface smoothness of the resultant molded article tends to degrade. If it is less than 0.05 μm, aggregation will easily occur in the composition. Also, since the heavy calcium carbonate is obtained by smashing natural mineral, it is difficult to produce one having an average particle size of less than 1 μm. Therefore, the light calcium carbonate capable of easily producing one having an average particle size of less than 1 μm is more preferable.

The calcium carbonate (C) according to the present invention is used to improve heat resistance and rigidity required for the resin composition as a light reflector. The content of the calcium carbonate (C) is greater than or equal to 1 part by mass, preferably greater than or equal to 5 parts by mass, more preferably greater than or equal to 8 parts by mass, with respect to 100 parts by mass of the total polyester resin contained in the thermoplastic polyester resin composition of the present invention. Note however that, in order to increase the surface smoothness of the resultant molded article, the content of the calcium carbonate (C) needs to be less than or equal to 20 parts by mass, preferably less than or equal to 15 parts by mass, more preferably less than or equal to 12 parts by mass. If the content exceeds 20 parts by mass, the filler may float out, degrading the surface smoothness of the resultant molded article, and whitening may occur after metallization.

The calcium carbonate (C) according to the present invention needs to be surface-treated for enhancing dispersibility in the resin composition. Examples of the surface treatment include treatment with a surface treatment agent such as an aminosilane coupling agent, an epoxysilane coupling agent, a titanate-based coupling agent, and an aluminate-based coupling agent, treatment with silica, treatment with fatty acid, treatment with SiO₂—Al₂O₃, and neutralization treatment with an acidic compound such as a phosphorus compound. These treatments may be combined. From the viewpoint of fogging properties, treatment with silica, treatment with an epoxysilane coupling agent, and treatment with an alkylsilane coupling agent are preferable; treatment with silica and treatment with an alkylsilane coupling agent are more preferable; and treatment with silica is most preferable. Composite treatment of silica treatment and epoxysilane coupling agent treatment and composite treatment of silica treatment and alkylsilane coupling agent treatment are also most preferable.

The surface treatment method for the calcium carbonate (C) is not particularly limited, but a method of physically mixing the calcium carbonate (C) and any of the treatment agents can be used. For example, a grinding machine such as a roll mill, a high-speed rotary grinding machine, and a jet mill or a mixing machine such as a Nauta mixer, a ribbon mixer, and a Henschel mixer can be used.

The average particle size of the calcium carbonate (C) does not substantially change before and after the surface treatment. However, according to the present invention, the average particle size of the calcium carbonate (C) subjected to surface treatment refers to an average particle size of the calcium carbonate (C) after the surface treatment.

An inorganic filler other than the calcium carbonate (C) may be contained in the thermoplastic polyester resin composition within the range of not impairing the effect of the present invention. In this case, the average particle size of an inorganic filler other than the calcium carbonate (C) is preferably less than or equal to 3 μm, more preferably less than or equal to 2 μm. The calcium carbonate (C) is preferably in a range of greater than or equal to 70% by mass, more preferably in a range of greater than or equal to 80% by mass, with respect to 100% by mass of the total inorganic filler.

The multifunctional glycidyl group-containing styrene-based polymer (D) according to the present invention is preferably a multifunctional glycidyl styrene acrylic polymer having a weight-average molecular weight (Mw) of greater than or equal to 1000 and an epoxy value of greater than or equal to 0.5 meq/g. The weight-average molecular weight (Mw) is more preferably greater than or equal to 5000, further preferably greater than or equal to 7000, especially preferably greater than or equal to 8000. If the weight-average molecular weight (Mw) is less than 1000, the number of glycidyl groups per molecule may be small, reducing an effect of capturing an oligomer and a monomer of the polyester resin and free organic carboxylic acid contained in a fatty acid ester-based mold release agent, etc. The weight-average molecular weight (Mw) is preferably less than or equal to 50000 from the viewpoint of compatibility with the polyester resin. The epoxy value is preferably greater than or equal to 0.6 meq/g, more preferably greater than or equal to 0.65 meq/g. If the epoxy value is less than 0.5 meq/g, the effect of capturing an oligomer and a monomer of the polyester resin and free organic carboxylic acid, etc. may decrease. The epoxy value is preferably less than or equal to 3 meq/g from the viewpoint of restraining excessive reaction with the polyester resin. The multifunctional glycidyl group-containing styrene-based polymer (D) according to the present invention is contained in 0.05 to 3 parts by mass with respect to 100 parts by mass of the total polyester contained in the thermoplastic polyester resin composition of the present invention.

By setting the multifunctional glycidyl group-containing styrene-based polymer (D) to an amount within the above range, gasification ingredients such as an oligomer and a monomer of the polyester and free organic carboxylic acid can be efficiently captured, whereby excellent low gas properties can be achieved.

As the multifunctional glycidyl group-containing styrene-based polymer (D) according to the present invention, one good in compatibility with the polyester resin and small in difference in refractive index from the polyester resin is preferable. The weight-average molecular weight (Mw) is preferably greater than or equal to 1000, and the epoxy value is preferably greater than or equal to 0.5 meq/g, more preferably greater than or equal to 1.0 meq/g.

As a specific ingredient of the multifunctional glycidyl group-containing styrene-based polymer (D), a copolymer of a glycidyl group-containing unsaturated monomer and a vinyl aromatic monomer is preferable.

Examples of the glycidyl group-containing unsaturated monomer include an unsaturated carboxylic glycidyl ester and unsaturated glycidyl ether. Examples of the unsaturated carboxylic glycidyl ester include glycidyl acrylate, glycidyl methacrylate, and an itaconic acid monoglycidyl ester. Among others, glycidyl methacrylate is preferable. Examples of the unsaturated glycidyl ether include vinyl glycidyl ether, allyl glycidyl ether, 2-methylallyl glycidyl ether, and methacryl glycidyl ether. Among others, methacryl glycidyl ether is preferable.

Examples of the vinyl aromatic monomer include styrene-based monomers such as styrene, methylstyrene, dimethylstyrene, and ethylstyrene. Among others, styrene is preferable.

The ratio of copolymerization between the glycidyl group-containing unsaturated monomer and the vinyl aromatic monomer is such that the copolymerized amount of the glycidyl group-containing unsaturated monomer is preferably 1 to 30% by mass, more preferably 2 to 20% by mass.

If the copolymerized amount of the glycidyl group-containing unsaturated monomer is less than 1% by mass, the effect of capturing an oligomer and a monomer of the polyester resin and free organic carboxylic acid, etc. will decrease, and this tends to inversely affect the low gas properties. If it exceeds 30% by mass, the stability as the resin composition may be impaired.

Within the range of not impairing compatibility with the polyester resin, an alkyl ester having a carbon number of 1 to 7 of acrylic acid or methacrylic acid, e.g., a (meth)acrylic acid ester monomer such as methyl, ethyl, propyl, isopropyl, and butyl esters of (meth)acrylic acid, a (meth)acrylic nitrile monomer, a vinyl ester monomer such as vinyl acetate and vinyl propylate, a (meth)acrylamide monomer, and a monomer such as a monoester and a diester of maleic anhydride and maleic acid, may be copolymerized. Note however that it is more preferable not to have α-olefins such as ethylene, propylene, and butene-1 copolymerized because these tend to impair compatibility with the polyester resin.

If the content of the multifunctional glycidyl group-containing styrene-based polymer (D) is greater than 3 parts by mass, gelation may occur by reaction with the polyester resin. If the content of the multifunctional glycidyl group-containing styrene-based polymer (D) is less than 0.05 parts by mass, the effect of capturing an oligomer and a monomer of the polyester resin and free organic carboxylic acid, etc. may decrease, impairing the low gas properties. The blending amount of the multifunctional glycidyl group-containing styrene-based polymer (D) is preferably 0.1 to 2 parts by mass, more preferably 0.15 to 1 part by mass, with respect to 100 parts by mass of the total polyester resin contained in the thermoplastic polyester resin composition of the present invention.

The phosphorus-based compound (E) according to the present invention is used as an antioxidant and a peroxide capture agent and as an inactivator of a titanium catalyst. Examples of the phosphorus-based compound (E) include phosphoric acid, phosphorous acid, phosphinic acid, phosphonic acid, and their derivatives. Specific examples include an inorganic phosphoric salt such as monosodium phosphate, disodium phosphate, trisodium phosphate, sodium phosphite, calcium phosphite, magnesium phosphite, and manganese phosphite; a phosphoric ester such as a phosphoric acid trimethyl ester, a phosphoric acid tributyl ester, a phosphoric acid triphenyl ester, a phosphoric acid monomethyl ester, and a phosphoric acid dimethyl ester; phosphites such as triphenyl phosphite, trioctadecyl phosphite, tridecyl phosphite, trinonylphenyl phosphite, diphenylisodecyl phosphite, bis(2,6-di-tert-butyl-4-methylphenyl)pentaerythritol diphosphite (molecular weight: 633, available as product name. ADEKA STAB PEP-36 manufactured by ADEKA Corporation, for example; this also applies to the followings); bis(2,4-di-tert-butylphenyl)pentaerythritol diphosphite (“ADEKA STAB PEP-24G,” molecular weight: 604), tris(2,4-di-tert-butylphenyl) phosphite, distearylpentaerythritol diphosphite (“ADEKA STAB PEP-8,” molecular weight: 733), bis(nonylphenyl)pentaerythritol diphosphite (“ADEKA STAB PEP-4C,” molecular weight: 633), tetra(tridecyl-4,4′-isopropylidenediphenyl) diphosphite, and 2,2-methylene bis(4,6-di-tert-butylphenyl)octyl phosphite; phosphinates such as dimethyl phosphinate and phenyl phosphinate; and phosphonates such as phenyl phosphonate, a phenylphosphonic acid dimethyl ester, and a phenylphosphonic acid diethyl ester. These can be used singularly or as a mixture thereof. As a metal inactivator, usable are commercial products such as bis-benzylidene hydrazide oxalate (product name: Inhibitor OABH manufactured by Eastman Chemical Company), decamethylene dicarboxylic acid disalicyloyl hydrazide (product name: ADEKA STAB CDA-6 manufactured by ADEKA Corporation), N,N′-bis[3-(3,5-di-t-butyl-4-hydroxyphenyl)propionyl]hydrazine (product name: Irganox MD 1,024 manufactured by Ciba-Geigy), and 2,2′-oxamidebis[ethyl3-(3,5-t-butyl-4-hydroxyphenyl)propionate] (product name: Naugard XL-1 manufactured by Shiraishi Kogyo Kaisha, Ltd.).

According to the present invention, in order to improve mold releasability, a mold release agent is preferably contained. As the mold release agent, no particular limitation is imposed as far as such an agent is usable for polyester. Examples of the mold release agent include long-chain fatty acid or its ester and metal salt, an amide-based compound, polyethylene wax, and polyethylene oxide. As the long-chain fatty acid, one having a carbon number of greater than or equal to 12 is especially preferable, examples of which include stearic acid, 12-hydroxystearic acid, behenic acid, and montanic acid. Part or the entire of carboxylic acid may be esterified with monoglycol and polyglycol, or may form metal salt. Examples of the amide-based compound include ethylene bisterephthalamide and methylene bisstearylamide. Specific examples of these include Rikester L-8483 and Poem TR-FB manufactured by RIKEN VITAMIN Co., Ltd. One kind or two or more kinds of these mold release agents can be used in combination. These mold release agents may be used singularly or as a mixture.

The content of the mold release agent is not particularly limited, but it is preferably 0.05 to 5 parts by mass, more preferably 0.05 to 3 parts by mass, further preferably 0.1 to 1 part by mass, with respect to 100 parts by mass of the total polyester resin contained in the resin composition of the present invention. If the content is less than 0.05 parts by mass, sufficient mold releasability will not be exhibited. If it exceeds 5 parts by mass, generation of gas may increase, worsening residues on mold and fogging properties, and thus the object of the present invention may not be attained.

Various additives can be contained in the thermoplastic polyester resin composition of the present invention, as required, within the range of not impairing the properties as the present invention. Examples of known additives include a coloring agent such as a pigment, a heat-resistant stabilizer, an antioxidant, a UV absorber, a light stabilizer, a plasticizer, a denaturant, an antistatic agent, a frame retardant, and a dye. In the thermoplastic polyester resin composition of the present invention, the total of the ingredients (A), (B), (C), and (D), or the total of the ingredients (A), (B), (C), (D), and (E), preferably occupies greater than or equal to 85% by mass, more preferably greater than or equal to 90% by mass, further preferably greater than or equal to 95% by mass, of the entire thermoplastic polyester resin composition. The ingredients (B) and (E) may be 0.

As the method for producing the thermoplastic polyester resin composition of the present invention, the ingredients (A) to (D), and the ingredients (E) and (F) and various stabilizers and pigments, etc., as required, may be mixed together, melted, and kneaded. For melting and kneading, any of conventionally known methods can be used, and a single screw extruder, a twin screw extruder, a pressure kneader, a Banbury mixer, etc. are usable. Among others, it is preferable to use a twin screw extruder. General melting and kneading conditions are a cylinder temperature of 220 to 270° C. and a kneading time of 2 to 15 minutes for a twin screw extruder.

The light reflector component of the present invention includes the thermoplastic polyester resin composition of the present invention, and can be manufactured by molding the thermoplastic polyester resin composition of the present invention. The molding method is not particularly limited, but a known method such as injection molding, extrusion molding, and blow molding can be used. Among others, from the viewpoint of versatility, injection molding is preferably used. In particular, it is preferable to manufacture the component by a manufacturing method including a step of molding by injecting the composition into a mold at least part of an inner surface of which is a mirror surface.

The light reflector of the present invention is obtained by directly forming a light-reflecting metal layer on at least part of the surface of the light reflector component of the present invention by metallization. The metallization is not particularly limited, and a known method can be used.

Examples of the thus-obtained light reflector include light reflector components of automotive lamps such as head lamps and rear lamps, e.g., extensions, reflectors, and housings, and light reflectors used for lighting fixtures.

### EXAMPLES

While the present invention will be described hereinafter by way of examples more specifically, it should be noted that the present invention is not be limited to these examples. Note that measured values and determinations shown in the examples are obtained by the following methods.

(1) Inherent Viscosity (IV):

Measured by an Ubbelohde viscometer using a mixed solvent of phenol/tetrachloroethane (mass ratio: 1/1) at 30° C.

(2) Titanium Content:

Measured by wet-degrading polybutylene terephthalate with high-purity sulfuric acid for electronics industry and high-purity nitric acid for electronics industry and using a high-resolution inductively coupled plasma (ICP)—mass spectrometer (MS) (manufactured by ThermoQuest Corporation).

(3) Terminal Carboxyl Group Concentration (Acid Value: eq/ton):

Titrated by dissolving 0.5 g of polybutylene terephthalate in 25 ml of benzyl alcohol and using a 0.01 mol/l solution of sodium hydroxide in benzyl alcohol. As an indicator, 0.10 g of phenol phthalein dissolved in a mixed solution of 50 mL of ethanol and 50 mL of water was used.

(4) Terminal Hydroxyl Group Concentration (OH Value)

The OH values of polybutylene terephthalate and polyethylene terephthalate were determined quantitatively by ¹H-NMR measurement at a resonant frequency of 500 MHz. As the measuring apparatus. NMR apparatus AVANCE-500 manufactured by Bruker was used, and a measurement liquid was prepared in the following manner.

A specimen, 10 mg, was dissolved in 0.12 ml of heavy chloroform/hexafluoroisopropanol (volume ratio: 1/1), and then 0.48 ml of heavy chloroform and 5 μl of heavy pyridine were added and agitated well. The resultant solution was charged into an NMR tube to perform ¹H-NMR measurement.

Heavy chloroform was used for a lock solvent, and the cumulative number was set to 128.

The OH value quantity determination was performed in the following manner.

When the peak of chloroform is 7.29 ppm, the peak of 8.10 ppm is terephthalic acid peak (A) derived from polybutylene terephthalate or polyethylene terephthalate. Further, for the polybutylene terephthalate resin, terminal 1,4-butanediol peak (B) is detected at 3.79 ppm. For the polyethylene terephthalate resin, terminal ethylene glycol peak (C) is detected at 4.03 ppm. Using A to C in parentheses as values of integral of the respective peaks, the OH values were determined from the following equations.

For polybutylene terephthalate resin: (B×1000000/2)/(A×220/4)=OH value (eq/ton)

For polyethylene terephthalate resin: (C×1000000/2)/(A×192/4)=OH value (eq/ton)

(5) Average Particle Size of Filler

The average particle size of a filler examined was determined by an electron microscope method of calculating the particle size from an electron microscope image. While a method of calculating the particle size from a scanning electron microscope (SEM) image will be described hereinafter, the method is not particularly limited, but a transmission electron microscope (TEM) image can also be used.

The method of preparing the specimen is as follows: 3 g of an inorganic filler and 60 g of a methanol solvent were put in a beaker (100 ml), suspended, and preliminarily dispersed under fixed conditions of 300 μA and one minute using ultrasonic disperser US-300AT (manufactured by NIPPON SEIKI CO., LTD.). The resultant liquid was put thinly on a specimen support using a 0.5 ml syringe and dried, to prepare the specimen.

The prepared specimen was observed with SEM at a magnifying power capable of counting 100 to 500 particles, and then 100 to 500 particles were counted from an end in order using image analysis type particle size analysis software ImageJ (open source), to calculate the average particle size.

(6) Filler Dispersibility

A 100 mm×100 mm×2 mm-thick flat molded article molded using injection molding machine EC100N (manufactured by TOSHIBA MACHINE CO., LTD.) was cut with a diamond cutter or a glass cutter, to form a section, and presence/absence of aggregates was visually determined from a SEM photograph of the section.

⊙: No aggregates

◯: There are aggregates in a slight number.

Δ: Aggregates are observed sporadically.

x: There are many aggregates.

(7) Surface Appearance (Specularity)

A 100 mm×100 mm×2 mm-thick flat molded article was injection-molded using injection molding machine EC100N (manufactured by TOSHIBA MACHINE CO., LTD.) and using a mold having a mirror surface polished with #6000 file as one surface. The molding was performed at a cylinder temperature of 260° C., a mold temperature of 60° C., a cycle time of 40 seconds, and a low injection speed at which the filler tends to float out to the surface. The mirror surface of the resultant molded article was evaluated visually on presence/absence of defects (whitening, surface roughness)

⊙: Neither whitening nor surface roughness is recognized.

◯: Whitening and surface roughness are slightly recognized depending on the angle of visual observation, but at such a level that no problem will be practically caused.

Δ: Whitening and surface roughness are recognized.

x: Whitening and surface roughness are extremely significant.

(8) Fogging Properties (Haze %)

Small pieces each having a size of approximately 30 mm×30 mm were cut out from a molded article molded using injection molding machine EC100N (manufactured by TOSHIBA MACHINE CO., LTD.). A total of 10 g of them were put in a glass cylinder (ϕ65×80 mm) covered with aluminum foil as its bottom, and set on a hot plate (Neo Hot Plate HT-1000 manufactured by As One Corporation). After the glass cylinder was lidded with a slide glass, heat treatment was performed at a hot plate setting temperature of 180° C. for 24 hours. As a result of the heat treatment, deposits such as decomposed matters having sublimated from the resin composition attached to the inner wall of the slide glass. The haze value (haze %) of the slide glass was measured using hazemeter NDH2000 (manufactured by NIPPON DENSHOKU INDUSTRIES CO., LTD.).

(9) Residues on Mold Acceleration Test

Continuous molding was performed using injection molding machine EC100N (manufactured by TOSHIBA MACHINE CO., LTD.) using a continuous molding evaluation type mold (having a cavity with an outer diameter of 30 mm, an inner diameter of 20 mm, and a thickness of 3 mm, and a flow terminal is a recessed part and no degassing) by a short shot method so that contained ingredients such as an oligomer could easily accumulate in the recessed part on the side opposite to the gate part, to observe residues on mold. The molding was performed at a cylinder temperature during molding of 260° C., a mold temperature of 60° C., and a cycle time of 40 seconds, and residues on mold after 20 shots was evaluated. Residues on mold were photographed with a digital camera, and evaluated after execution of grayscale processing for color homogenization.

⊙: No residues are recognized.

◯: Residues are hardly recognized.

Δ: Residues are faintly recognized in the center near the recessed part on the side opposite to the gate part.

x: Residues are conspicuous with black in a clear outline in the center near the recessed part on the side opposite to the gate part.

Blending ingredients used in the examples and comparative examples are as follows.

(A) Polybutylene Terephthalate Resin

(A-1) Polybutylene terephthalate resin: IV=0.82 dl/g, acid value=10 eq/ton, OH value=100 eq/ton, titanium content=30 ppm

(A-2) Polybutylene terephthalate resin: IV=1.04 dl/g, acid value=23 eq/ton, OH value=43 eq/ton, titanium content=40 ppm

(A-3) Polybutylene terephthalate resin: IV=0.83 dl/g, acid value=30 eq/ton, OH value=80 eq/ton, titanium content=80 ppm

(B) Polyethylene Terephthalate Resin

(B-1) Polyethylene terephthalate resin: IV=0.62 dl/g, acid value=30 eq/ton, OH value=60 eq/ton

(C) Inorganic Filler

(C-1) Light calcium carbonate (treated with silica, average particle size: 0.15 μm [electron microscope method]): RK-87BR2F (manufactured by Shiraishi Kogyo Kaisha, Ltd.)

(C-2) Light calcium carbonate (treated with silica/epoxysilane coupling agent, average particle size: 0.15 μm [electron microscope method]): RK-92BR3F (manufactured by Shiraishi Kogyo Kaisha, Ltd.)

(C-3) Light calcium carbonate (treated with silica/alkylsilane coupling agent, average particle size: 0.15 μm [electron microscope method]): RK-82BR1F (manufactured by Shiraishi Kogyo Kaisha, Ltd.)

(C-4) Light calcium carbonate (neutralized with acid, average particle size: 0.15 μm [electron microscope method]): RK-75NC (manufactured by Shiraishi Kogyo Kaisha, Ltd.)

(C-5) Light calcium carbonate (treated with fatty acid, average particle size: 0.15 μm [electron microscope method]): Vigot-10 (manufactured by Shiraishi Kogyo Kaisha, Ltd.)

(C-6) Light calcium carbonate (No surface treatment, average particle size: 0.15 μm [electron microscope method]): Brilliant-1500 (manufactured by Shiraishi Kogyo Kaisha, Ltd.)

(C-7) Light calcium carbonate (No surface treatment, average particle size: 0.04 μm [electron microscope method]): NPCC-201 (manufactured by NAGASE & Co, Ltd.)

(C-8) Heavy calcium carbonate (No surface treatment, average particle size: 4.2 μm [laser diffraction method, particle size distribution: 50%], catalog value was used for average particle size): KS-1000 (manufactured by HAYASHI KASEI CO., LTD.)

(C-9) Light calcium carbonate (treated with silane coupling agent, average particle size: 3.0 μm [electron microscope method]): SL-101 (manufactured by Shiraishi Kogyo Kaisha, Ltd.)

(C-10) Fired kaolin (No surface treatment, average particle size: 0.8 μm [electron microscope method]: SATINTONE-5HB (manufactured by HAYASHI KASEI CO., LTD.)

(D) Multifunctional Glycidyl Group-Containing Styrene Acrylic Polymer

(D-1) ARUFON UG-4050 (manufactured by TOAGOSEI CO., LTD., Mw: 8500, epoxy value: 0.67 meq/g, refractive index: 1.55)

(D-2) ARUFON UG-4070 (manufactured by TOAGOSEI CO., LTD., Mw: 9700, epoxy value: 1.4 meq/g, refractive index: 1.57)

(E) Phosphorus-Based Compound

(E-1) ADEKA STAB PEP-36 (manufactured by ADEKA Corporation)

(E-2) ADEKA STAB CDA-6 (manufactured by ADEKA Corporation)

Mold Release Agent

Triglycerol behenic acid full ester: Poem TR-FB (manufactured by RIKEN VITAMIN Co., Ltd.)

Stabilizer

Antioxidant: Irganox 1010 (manufactured by BASF SE)

### Examples 1 to 14, Comparative Examples 1 to 9

To the blending ingredients shown in Tables 1 and 2, further added were 0.3 parts by mass of Poem TR-FB as a mold release agent and 0.2 parts by mass of Irganox 1010 as an antioxidant, and the resultant mixture was melted and kneaded with a same-direction twin screw extruder having a cylinder temperature set at 260° C. The resultant strands were cooled with water and pelletized. The resultant pellets were dried at 130° C. for 4 hours, and subjected to the evaluation tests described above. The results are shown in Tables 1 and 2.

TABLE 1

| | | Examples | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Blending | Polybutylene | 80 | 70 | 70 | 60 | 70 | 70 | 70 | 70 | 70 | 70 | | | | |
| compo- | terephthalate (A-1) | | | | | | | | | | | | | | |
| sition | Polybutylene | | | | | | | | | | | 70 | 70 | 70 | |
| (parts by | terephthalate (A-2) | | | | | | | | | | | | | | |
| mass) | Polybutylene | | | | | | | | | | | | | | 70 |
| | terephthalate (A-3) | | | | | | | | | | | | | | |
| | Polybutylene | 10 | 20 | 20 | 30 | 20 | 20 | 20 | 20 | 20 | 20 | 20 | 20 | 20 | 20 |
| | terephthalate (B-1) | | | | | | | | | | | | | | |
| | Light calcium | 9 | 9 | 9 | 9 | | | | | | | 9 | 9 | 9 | 9 |
| | carbonate (C-1) | | | | | | | | | | | | | | |
| | Light calcium | | | | | 9 | | | | | | | | | |
| | carbonate (C-2) | | | | | | | | | | | | | | |
| | Light calcium | | | | | | 3 | 9 | 15 | | | | | | |
| | carbonate (C-3) | | | | | | | | | | | | | | |
| | Light calcium | | | | | | | | | 9 | | | | | |
| | carbonate (C-4) | | | | | | | | | | | | | | |
| | Light calcium | | | | | | | | | | 9 | | | | |
| | carbonate (C-5) | | | | | | | | | | | | | | |
| | Light calcium | | | | | | | | | | | | | | |
| | carbonate (C-6) | | | | | | | | | | | | | | |
| | Light calcium | | | | | | | | | | | | | | |
| | carbonate (C-7) | | | | | | | | | | | | | | |
| | Heavy calcium | | | | | | | | | | | | | | |
| | carbonate (C-8) | | | | | | | | | | | | | | |
| | Light calcium | | | | | | | | | | | | | | |
| | carbonate (C-9) | | | | | | | | | | | | | | |
| | Fired kaolin (C-10) | | | | | | | | | | | | | | |
| | Multifunctional | 0.5 | 0.5 | | 0.5 | 0.5 | 0.5 | 0.5 | 0.5 | 0.5 | 0.5 | 0.5 | 0.5 | 0.5 | 0.5 |
| | glycidyl group- | | | | | | | | | | | | | | |
| | containing | | | | | | | | | | | | | | |
| | styrene acrylic | | | | | | | | | | | | | | |
| | polymer (D-1) | | | | | | | | | | | | | | |
| | Multifunctional | | | 0.5 | | | | | | | | | | | |
| | glycidyl group- | | | | | | | | | | | | | | |
| | containing | | | | | | | | | | | | | | |
| | styrene acrylic | | | | | | | | | | | | | | |
| | polymer (D-2) | | | | | | | | | | | | | | |
| | Phosphorus- | 0.1 | 0.1 | 0.1 | 0.1 | 0.1 | 0.1 | 0.1 | 0.1 | 0.1 | 0.1 | 0.1 | | | |
| | based compound | | | | | | | | | | | | | | |
| | (E-1) | | | | | | | | | | | | | | |
| | Phosphorus- | | | | | | | | | | | | 0.1 | | |
| | based compound | | | | | | | | | | | | | | |
| | (E-2) | | | | | | | | | | | | | | |
| Properties | Inorganic filler | ⊚ | ⊚ | ⊚ | ⊚ | ⊚ | ⊚ | ⊚ | ⊚ | ◯ | ◯ | ⊚ | ⊚ | ⊚ | ⊚ |
| of molded | dispersibility | | | | | | | | | | | | | | |
| article | Surface appearance | ◯ | ⊚ | ⊚ | ⊚ | ⊚ | ⊚ | ⊚ | ◯ | ◯ | ◯ | ⊚ | ⊚ | ⊚ | ⊚ |
| | Fogging properties | 6 | 6 | 6 | 7 | 6 | 6 | 6 | 7 | 9 | 10 | 5 | 5 | 6 | 13 |
| | (180° C., 24 hrs) | | | | | | | | | | | | | | |
| | Haze value (%) | | | | | | | | | | | | | | |
| | Residues on mold | ⊚ | ⊚ | ⊚ | ⊚ | ⊚ | ⊚ | ⊚ | ⊚ | ◯ | ◯ | ⊚ | ⊚ | ◯ | Δ |

TABLE 2

| | | Comparative Examples | | | | | | | | |
|---|---|---|---|---|---|---|---|---|---|---|
| | | 1 | 2 | 3 | 4 | 5 | 6 | 7 | 8 | 9 |
| Blending | Polybutylene | | | | | | 70 | 70 | 70 | 70 |
| compo- | terephthalate (A-1) | | | | | | | | | |
| sition | Polybutylene | | | | | | | | | |
| (parts by | terephthalate (A-2) | | | | | | | | | |
| mass) | Polybutylene | 70 | 70 | 70 | 70 | 70 | | | | |
| | terephthalate (A-3) | | | | | | | | | |
| | Polybutylene | 20 | 20 | 20 | 20 | 20 | 20 | 20 | 20 | 20 |
| | terephthalate (B-1) | | | | | | | | | |
| | Light calcium | | | | | | | 25 | 9 | 9 |
| | carbonate (C-1) | | | | | | | | | |
| | Light calcium | | | | | | | | | |
| | carbonate (C-2) | | | | | | | | | |
| | Light calcium | | | | | | | | | |
| | carbonate (C-3) | | | | | | | | | |
| | Light calcium | | | | | | | | | |
| | carbonate (C-4) | | | | | | | | | |
| | Light calcium | | | | | | | | | |
| | carbonate (C-5) | | | | | | | | | |
| | Light calcium | 9 | | | | | 9 | | | |
| | carbonate (C-6) | | | | | | | | | |
| | Light calcium | | 9 | | | | | | | |
| | carbonate (C-7) | | | | | | | | | |
| | Heavy calcium | | | 9 | | | | | | |
| | carbonate (C-8) | | | | | | | | | |
| | Light calcium | | | | 9 | | | | | |
| | carbonate (C-9) | | | | | | | | | |
| | Fired kaolin (C-10) | | | | | 9 | | | | |
| | Multifunctional | | | 0.5 | 0.5 | 0.5 | 0.5 | 0.5 | | 5 |
| | glycidyl group- | | | | | | | | | |
| | containing | | | | | | | | | |
| | styrene acrylic | | | | | | | | | |
| | polymer (D-1) | | | | | | | | | |
| | Multifunctional | | | | | | | | | |
| | glycidyl group- | | | | | | | | | |
| | containing | | | | | | | | | |
| | styrene acrylic | | | | | | | | | |
| | polymer (D-2) | | | | | | | | | |
| | Phosphorus- | 0.1 | | | | | | | | |
| | based compound | | | | | | | | | |
| | (E-1) | | | | | | | | | |
| | Phosphorus- | | | | | | | | | |
| | based compound | | | | | | | | | |
| | (E-2) | | | | | | | | | |
| Properties | Inorganic filler | Δ | X | X | Δ | X | Δ | Δ | ⊚ | ⊚ |
| of molded | dispersibility | | | | | | | | | |
| article | Surface appearance | Δ | Δ | X | Δ | Δ | Δ | Δ | ⊚ | ⊚ |
| | Fogging properties | 24 | 60 | 12 | 13 | 25 | 12 | 17 | 20 | 5 |
| | (180° C., 24 hrs) | | | | | | | | | |
| | Haze value (%) | | | | | | | | | |
| | Residues on mold | X | X | Δ | Δ | Δ | Δ | Δ | X | X |

The thermoplastic polyester resin compositions of the examples are successful in restraining aggregation of calcium carbonate fine particles, exhibiting not only excellence in the surface appearance of the molded articles, but also low fogging properties, and also restraining residues on mold.

On the contrary, the thermoplastic polyester resin compositions of the comparative examples fail in obtaining both surface smoothness and the effect of restraining residues on mold. In Comparative Examples 1 and 6, no surface treatment is performed for calcium carbonate particles, and in Comparative Example 2, the particle size of calcium carbonate is extremely small, causing significant aggregation of calcium carbonate and thus impairing the surface appearance of the molded article. These calcium carbonate particles are inferior in dispersibility, and thus shearing heat is imparted to the resin during melting and kneading, promoting decomposition of the resin. This increases residues on mold. In Comparative Examples 3 and 4, the particle size of calcium carbonate is so large, irrespective of whether or not surface treatment has been done, that the surface appearance of the molded article is impaired. In Comparative Example 5, the dispersibility of fired kaolin is poor, and thus surface appearance, residues on mold, and fogging are inferior.

In Comparative Example 7, the added amount of calcium carbonate is so large that the surface appearance of the molded article is impaired and also residues on mold and fogging are worsened. In Comparative Example 8, where the multifunctional glycidyl group-containing styrene acrylic polymer (D) is not added, it is unable to restrain fogging properties and residues on mold. In Comparative Example 9, addition of the multifunctional glycidyl group-containing styrene acrylic polymer (D) is so large that the viscosity of the resin significantly increases, worsening the appearance of the molded article. Also, shearing greatly influences on flowing resin during molding, so that gas increases, failing to restrain residues on mold.

### INDUSTRIAL APPLICABILITY

The thermoplastic polyester resin composition of the present invention is capable of restraining residues on mold due to continuous molding and capable of providing a molded article with high direct metallization properties, and thus is suitable for manufacture of light reflectors (specifically, extensions, reflectors, and housings) for automotive lamps (e.g., head lamps) and light reflectors for lighting fixtures.

1. A thermoplastic polyester resin composition containing 100 to 50 parts by mass of a polybutylene terephthalate resin (A) and 0 to 50 parts by mass of a polyethylene terephthalate resin (B), the resin composition containing 1 to 20 parts by mass of a surface-treated calcium carbonate (C) having an average particle size of 0.05 to 2 μm and 0.05 to 3 parts by mass of a multifunctional glycidyl group-containing styrene-based polymer (D) with respect to 100 parts by mass of a total polyester resin contained in the resin composition.

2. The thermoplastic polyester resin composition according to claim 1, wherein the surface treatment of the ingredient (C) is one kind or two or more kinds selected from silica treatment, epoxysilane coupling agent treatment, and alkylsilane coupling agent treatment.

3. The thermoplastic polyester resin composition according to claim 1, wherein the surface treatment of the ingredient (C) is any of silica treatment, composite treatment of silica treatment and epoxysilane coupling agent treatment, and composite treatment of silica treatment and alkylsilane coupling agent treatment.

4. The thermoplastic polyester resin composition according to claim 1, which contains 0.01 to 5 parts by mass of a phosphorus compound (E) with respect to 100 parts by mass of the total polyester resin.

5. The thermoplastic polyester resin composition according to claim 1, wherein the polybutylene terephthalate resin (A) is a polybutylene terephthalate resin having a titanium atom content of less than or equal to 60 ppm.

6. The thermoplastic polyester resin composition according to claim 1, wherein the polyethylene terephthalate resin (B) is a polyethylene terephthalate resin having an acid value of less than or equal to 30 eq/ton.

7. A light reflector component including the thermoplastic polyester resin composition according to claim 1.

8. A light reflector having the light reflector component according to claim 7 on at least part of a surface of which a light-reflecting metal layer is directly formed.

9. A method for manufacturing a light reflector component, the method comprising a step of molding by injecting the thermoplastic polyester resin composition according to claim 1 into a mold at least part of an inner surface of which is a mirror surface.

10. A method for producing a thermoplastic polyester resin composition, the method comprising a step of melting and kneading at least a polybutylene terephthalate resin (A), a polyethylene terephthalate resin (B), a surface-treated calcium carbonate (C) having an average particle size of 0.05 to 2 μm, and a multifunctional glycidyl group-containing styrene-based polymer (D), wherein
a blending ratio of (B) is 0 to 50 parts by mass relative to 100 to 50 parts by mass of (A), and blending ratios of (C) and (D) are 1 to 20 parts by mass for (C) and 0.05 to 3 parts by mass for (D), with respect to 100 parts by mass of a total polyester resin contained in the resin composition.

11. The method for producing a thermoplastic polyester resin composition according to claim 10, wherein, as the polybutylene terephthalate resin (A), a polybutylene terephthalate resin having a titanium atom content of less than or equal to 60 ppm is used.

12. The method for producing a thermoplastic polyester resin composition according to claim 10, wherein, as the polyethylene terephthalate resin (B), a polyethylene terephthalate resin having an acid value of less than or equal to 30 eq/ton is used.

13. The thermoplastic polyester resin composition according to claim 3, which contains 0.01 to 5 parts by mass of a phosphorus compound (E) with respect to 100 parts by mass of the total polyester resin.

14. The thermoplastic polyester resin composition according to claim 3, wherein the polybutylene terephthalate resin (A) is a polybutylene terephthalate resin having a titanium atom content of less than or equal to 60 ppm.

15. The thermoplastic polyester resin composition according to claim 3, wherein the polyethylene terephthalate resin (B) is a polyethylene terephthalate resin having an acid value of less than or equal to 30 eq/ton.

16. A light reflector component including the thermoplastic polyester resin composition according to claim 3.

17. A method for manufacturing a light reflector component, the method comprising a step of molding by injecting the thermoplastic polyester resin composition according to claim 3 into a mold at least part of an inner surface of which is a mirror surface.

18. A light reflector having the light reflector component according to claim 16 on at least part of a surface of which a light-reflecting metal layer is directly formed.
